(19) United States
(12) Patent Application Publication
(10) Pub. No.: US 2006/0090440 A1
(43) Pub. Date: May 4, 2006

(54) CROP BLOWER

(76) Inventor: Roy M. GULLICKSON, Barons, Alberta (CA)

Correspondence Address: EDWARD YOO C/O BENNETT JONES, 1000 ATCO CENTRE, 10035 - 105 STREET, EDMONTON, ALBERTA, AB, T5J3T2, CA

(21) Appl. No.: 11/163,684

(22) Filed: Oct. 27, 2005

Related U.S. Application Data
(60) Provisional application No. 60/623,403, filed on Oct. 27, 2004.

(51) Int. Cl. A01D 34/03

(52) U.S. Cl. 56/13.9

(57) ABSTRACT

The present invention relates to a crop blower apparatus, and more particularly to an apparatus for blowing crops towards the cutting knives of combine harvesters. The crop blower disclosed has a series of tangential flow blowers aligned along a continuous interconnected sectional drive shaft. The crop blower is mounted to the arms of a combine harvester using a pair of complimentary mounting arms. The sectional drive shaft design facilitates expedited repair work. The crop blower uses peripheral centrifugal blowers to maintain the volume of air flow at the ends of the apparatus to prevent blockage. The perforated metal blower design promotes high levels of air flow, and the positioning of the blowers relative to the discharge duct greatly improves the efficiency of the crop blower apparatus.

### CROSS REFERENCE TO RELATED APPLICATIONS

This application claims the priority benefit of U.S. Provisional Patent Application No. 60/623,402 filed on Oct. 27, 2004 entitled “Crop Blower”, the contents of which are incorporated herein by reference.

### FIELD OF THE INVENTION

The present invention relates to a crop-blowing apparatus, and more particularly to an apparatus for blowing crops towards the cutting knives of combine harvesters.

### BACKGROUND OF THE INVENTION

Conventional combine harvesters generally use a bat reel mounted on front facing arms to physically direct the crops to the cutting components of the harvester. As an alternative to the conventional bat reel, crop blowers have been developed for directing crops towards the harvesting machinery using streams of air. Crop blowers potentially offer the advantages of improved cutting action and greater crop yield. Earlier crop blowers comprised a blower mounted to the rear of the combine crop cutting header adjacent to the power shaft. These types of crop blowers were driven by belts extending from the power shaft. Typically, a flexible air tube was employed to carry the air flow from the blower forwards to a manifold positioned before the crop cutting knife. The manifold had number of ducts and associated nozzles which delivered the forced air at high speed to direct the standing crop back into the cutting machinery.

However, early crop blowers were limited by their ability to generate sufficient air flow to properly direct the crop. Certain types of crops, and certain crop conditions required greater air forces than the early crop blowers could generate. One response to this problem was the development of crop blowers with separate fans positioned at each end of the table. However, these types of blowers were expensive to produce, consumed a lot of power, and only generated a marginally improved air flow.

Other crop blowers employ the use of a series of aligned centrifugal blowers or tangential flow blowers, also commonly referred to as vortex fans, which generates greater blown air forces. Crop blowers having a series of separate, or interconnected blowers with continuous shafts and intermediate bearing support members were developed to overcome the problems associated with the physical stress that would be experienced by a single shafted blower that is bearing mounted at each end. The use of a series of interconnected blowers extending across the width of the harvester allows a high volume of air to be applied to the crop while greatly reducing the power requirements of the apparatus. One such type of crop blower comprises single beam like member that extends the width of the harvester, and which is shaped to form an elongate tubular housing for a series of interconnected blowers. The blowers are comprised of blades and mounted in position parallel to a drive shaft. The blowers draw air in through one side of the blower and discharge the generated air flow through the other side of blower. The discharged air is channeled through nozzles down towards the crop and the cutting machinery. Such crop blowers have means for mounting the blower to the arms of a conventional combine harvester. However, this type of crop blower has a number of problems. The widths of the arms of combine harvesters vary and there is no means of shortening or lengthening the crop blowers accordingly. Another problem is that the air-flow at each end of each such crop blowers is usually lower than the air flow in the middle and is often insufficient to effectively keep the table ends clear of crop materials, resulting in blockages. Further, the configuration of the blades, and positioning of the blower within the housing, in existing crop blowers does not maximize efficiency, requiring great rotor speeds to generate large air flows. Operating at high rotation speeds consumes large amounts of energy and makes the crop blowers more prone to mechanical wear and failure. Also, in this type of crop blower, it sometimes is necessary to replace the bearings that support the drive shaft. Such repairs require considerable disassembly and are time consuming and expensive.

What is needed is a crop blower which overcomes the problems associated with the existing crop blowers.

### SUMMARY OF THE INVENTION

The present invention is directed to a crop blowing apparatus for use on a combine harvester.

Accordingly, in one aspect of the invention, the invention comprises a crop blower apparatus for use with a combine harvester having a crop receiving portion, the apparatus comprising:
(a) an elongate structural member having a substantially perpendicular end plate at each end, each end plate having a bearing unit;
(b) a drive shaft comprised of a plurality of axially aligned interconnected sections, the drive shaft extending continuously between the end plates in an orientation that is substantially parallel to the elongate structural member;
(c) a plurality of intermediate support plates for supporting the drive shaft, the intermediate support plates being attached to the structural member in a substantially perpendicular orientation, and each intermediate support plate having a bearing unit;
(d) means for rotating the drive shaft;
(e) a plurality of blowers mounted to and aligned with the axis of the drive shaft;
(f) a lower housing attached to the end plates, the structural member and the intermediate support plates;
(g) a vortex stabilizer attached to the end plates, the structural member and the intermediate support plates, the lower housing and vortex stabilizer cooperating to form a discharge duct for directing the air flow generated by the blowers;
(h) an air intake screen releasably attached to one or both of the structural member and the vortex stabilizer;
(i) means for mounting the crop blower to the combine harvester in a position forward of the crop receiving portion of the combine harvester;
(j) the crop blower apparatus further comprising any one or more features selected from the group consisting of:
   (i) means for extending the length of the crop blower;
   (ii) positioning of the discharge duct and blower such that greater than 145° of the circumference of the blower is exposed to the discharge duct;
   (iii) a centrifugal blower releasably attached to each end plate aligned with the blowers for increasing the air flow at the ends of the crop blower;
   (iv) the blowers being formed from sheet metal that has been perforated to form a plurality of blades; and
   (v) the drive shaft sections being interconnected by torque transferring means and the drive shaft sections being positioned such that the drive shaft sections interconnect within the bearing units located on the intermediate support plates.

In one embodiment, the selected feature comprises means for extending the length of the crop blower. In another embodiment, the selected feature comprises positioning of the discharge duct and blower such that greater than 145° of the circumference of the blower is exposed to the discharge duct. In a further embodiment, the selected feature comprises a centrifugal blower aligned with the blowers releasably attached to each end plate for increasing the air flow at the ends of the crop blower. In one embodiment, the selected feature comprises the blowers being formed from sheet metal that has been perforated to form a plurality of blades. In another embodiment, the selected feature comprises the drive shaft sections being interconnected by torque transferring means and the drive shaft sections being positioned such that the drive shaft sections interconnect within the bearing units located on the intermediate support plates and the end plate.

In one embodiment the means for extending the length of the crop blower comprises at least one extension blower unit having at least one additional drive shaft section, at least one additional blower, housing having an air intake and a discharge duct, the extension blower unit being releasably attachable to either one of the end plates. In another embodiment the means for mounting the crop blower to the harvester comprises two support shaft members extending out of the end of the crop blower, each support shaft being attached to a mounting arm. In an embodiment, the means for rotating the drive shaft comprises a hydraulic motor. In one embodiment the means for rotating the drive shaft comprises a belt drive. In another embodiment the blowers comprise tangential flow fans and the air intake screen comprises a removable intake screen. In a further embodiment, the blowers comprise two semi circular sections of perforated sheet metal attached to circular end discs that are connected to, and radiates out from the drive shaft.

In one embodiment the apparatus further comprises intermediate bearing unit supports connected to the structural member for supporting the drive shaft sections. In another aspect of the invention, the invention comprises a crop blower apparatus for use with a combine harvester having a crop receiving portion, the crop blower apparatus comprising:
(a) an elongate structural member having a substantially perpendicular end plate at each end, each end plate having a bearing;
(b) a drive shaft comprised of a plurality of axially aligned interconnected sections, the drive shaft extending continuously between the end plates in an orientation that is substantially parallel to the elongate structural member;
(c) a plurality of intermediate support plates for supporting the drive shaft, the intermediate support plates being attached to the structural member in a substantially perpendicular orientation, and each intermediate support plate having a bearing;
(d) means for rotating the drive shaft;
(e) a plurality of blowers mounted to and aligned with the axis of the drive shaft;
(f) lower housing attached to the end plates, the structural member and the intermediate support plates
(g) a vortex stabilizer attached to the end plates, the structural member and the intermediate support plates, the lower housing and vortex stabilizer cooperating to form a discharge duct for directing the air flow generated by the blowers;
(h) an air intake screen releasably attached to one or both of the structural member and the vortex stabilizer;
(i) means for mounting the crop blower to the combine harvester in a position forward of the crop receiving portion of the combine harvester;
(j) an individually housed centrifugal blower at each end of the drive shaft for increasing the air flow at the ends of the crop blower.

### BRIEF DESCRIPTION OF THE DRAWINGS

The invention will now be described by way of an exemplary embodiment with reference to the accompanying simplified, diagrammatic, not-to-scale drawings. In the drawings:

FIG. 1 is a front perspective view of one embodiment of a crop blower.

FIG. 1A is a perspective view of an inlet screen portion of one embodiment of a crop blower.

FIG. 2 is a cross sectional view of one embodiment of a crop blower.

FIG. 3 is a fragmentary front elevation of the drive end of one embodiment of a crop blower.

FIG. 4 is a rear fragmentary perspective view of the non-drive end (L.H.) of one embodiment of a crop blower.

FIG. 4A is a rear perspective view of the vortex stabilizer of one embodiment of a crop blower.

FIG. 4B is a rear perspective view of a metal structural panel of one embodiment of a crop blower.

FIG. 4C is a fragmentary rear perspective view of a section of housing of one embodiment of a crop blower.

FIG. 5 is an elevation view of the L.H. end plate of the blower of one embodiment of a crop blower.

FIG. 6 is an elevation view of an intermediate support plate of one embodiment of a crop blower.

FIG. 7 is a fragmentary sectional view of an intermediate support plate assembly of one embodiment of a crop blower.

FIG. 8 is a fragmentary perspective view of two drive shaft end coupling configurations of one embodiment of a crop blower.

FIG. 9 is a partial exploded perspective view of a blower of one embodiment of a crop blower.

FIG. 9A is an enlarged partial perspective view of a blower of one embodiment of a crop blower.

FIG. 10 is an end elevation of an alternative arrangement of disc and blades of a blower of one embodiment of a crop blower.

FIG. 11 is a fragmentary L.H. perspective view of an alternative supplemental end blower of one embodiment of a crop blower.

FIG. 12 is a sectional view of the alternative supplemental end blower of one embodiment of a crop blower.

FIG. 13 is a rear sectional view of the alternative supplemental end blower of one embodiment of a crop blower.

FIG. 13A is rear sectional view of one end of a crop blower adjacent to an end of a extension blower unit of one embodiment of a crop blower.

FIG. 14 is an end view of a crop blower showing an end plate with associated flanges and bolt holes of one embodiment of a crop blower.

FIG. 15 is a rear isometric view an extension blower unit of one embodiment of a crop blower.

### DETAILED DESCRIPTION OF THE INVENTION

Definitions

When describing the present invention, the following terms have the following meanings, unless indicated otherwise. All terms not defined herein have their common art-recognized meanings:
1. The term “blower” means a rotary fan that blows air.
2. The term “centrifugal blower ” refers to a blower that blows air at right angles to its air intake.
3. The term “tangential flow blower” means a blower that is capable of in taking air tangentially with respect to the blower and of blowing air tangentially with respect to the blower.

Description

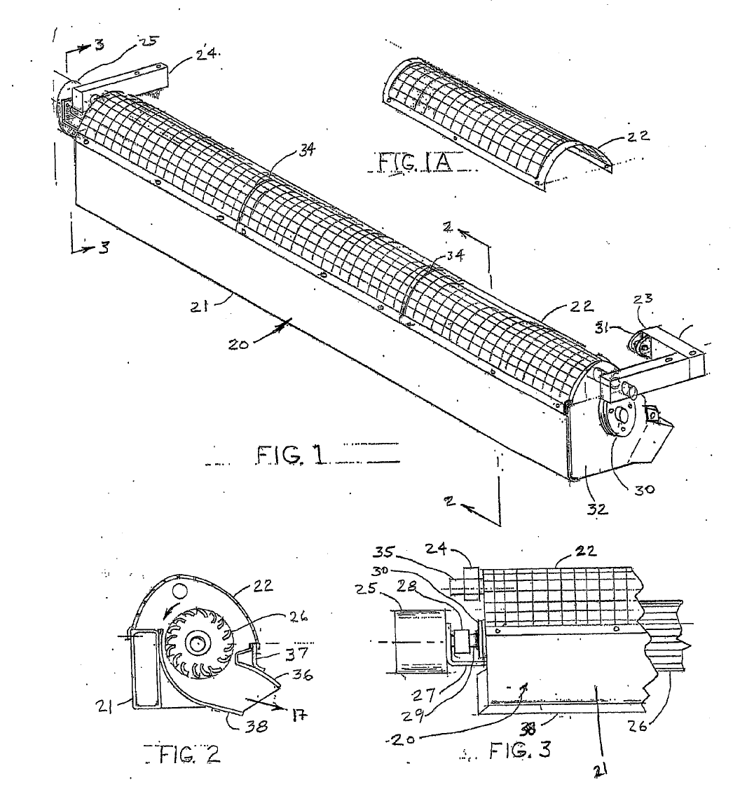

As shown in FIG. 1, the crop blower apparatus (20) has an elongate structural member (21), which may be a transverse hollow structure metal beam. At each end of the structural member (21) are substantially perpendicular end plates (32). Each end plate has a bearing unit (30) which rotatably supports the drive shaft (29). FIG. 5 shows an end plate (32) with attached flanges (39), (40), and (45) which provide attachment surfaces for intake screens (22), the lower housing (38), and the vortex stabilizer (36) and the vortex stabilizer support member (37). End plates (32) may be flared outward at their air exit end to allow air flow to spread out and provide air flow in the space between the ends of the crop blower (20) and the end of the combine harvester cutting mechanism

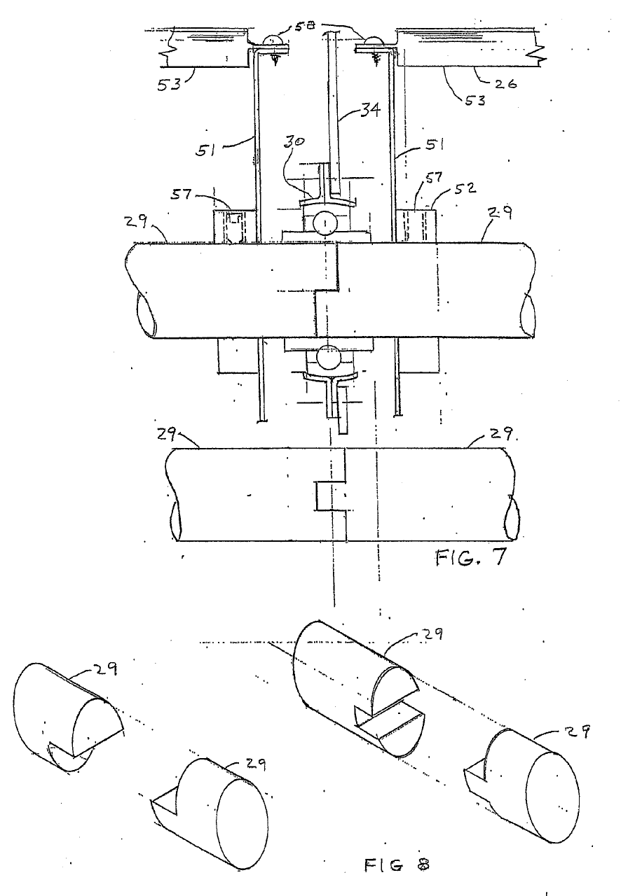

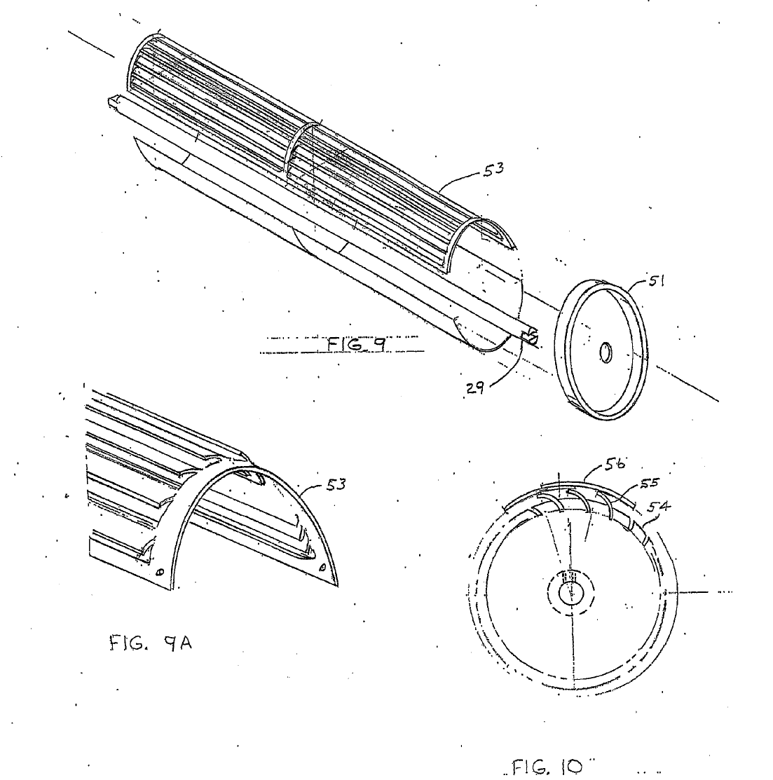

A drive shaft (29) extends continuously from one end plate (32) to the other (32) terminating in a bearing unit (30) mounted on each end plate. As shown in FIGS. 7 and 8, the drive shaft (29) is comprised of axially aligned interconnected sections (29). The drive shaft sections may be connected by any suitable torque-transferring means such as tongue and groove or ‘half moon’ machined shaft ends as illustrated in FIGS. 7 and 8. Preferably, the torque transferring means does not include external couplers, or couplers which enlarge the diameter of the shaft, which can interfere with the operation of the blowers.

As shown in FIG. 4, intermediate support plates (34) for supporting the drive shaft are attached to structural member (21) by welding or with mechanical fasteners. Each support plate (34) has an associated bearing unit (30). Bearing units (30) used on the end plates (32) and on the intermediate support plates (34) can be constructed from sheet metal housings and extended inner race ball bearings which are available as units from commercial bearing suppliers. Bearing units (30) attach to end plates (32) and support plates (34) by means of mechanical fasteners such as bolts, nuts and washers. FIG. 6 shows one of the intermediate support plates (34) with attached flanges (40), (43), and (45) which supports intake screens (22), lower housing (38), vortex stabilizer (36) and support member (37).

As shown in FIG. 7, the interconnected drive shaft sections (29) meet inside the extended inner races of the bearing units (30), as the interconnection does not enlarge the diameter of the shaft. The sectional configuration of the drive shaft allows for individual bearing or shaft replacement without extensive blower dismantling.

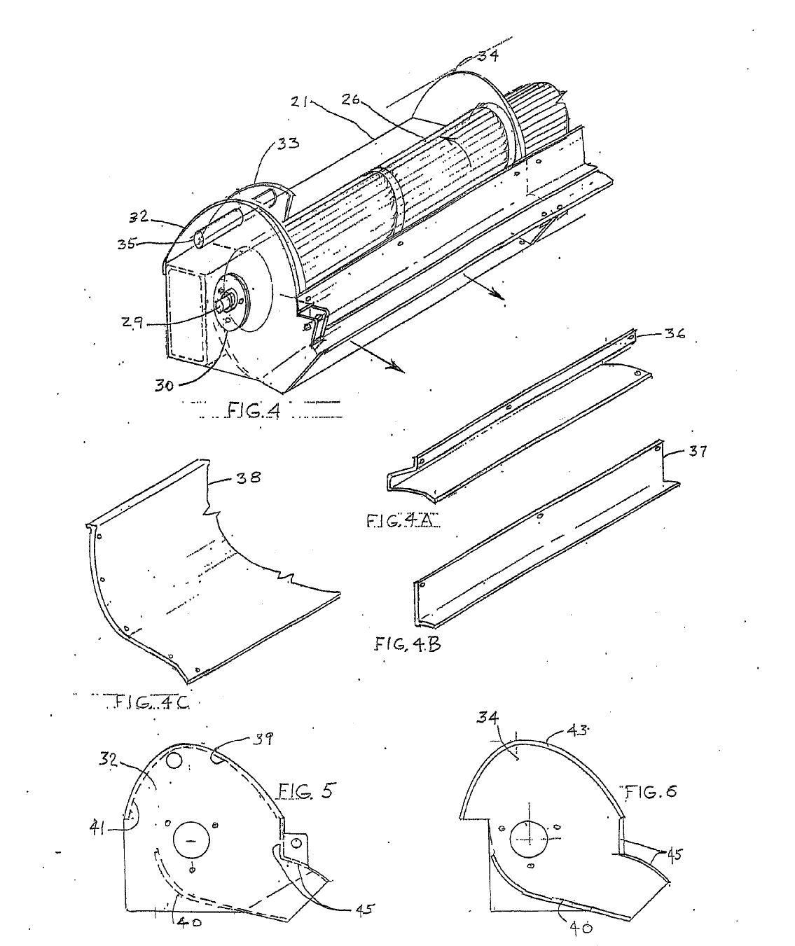

The crop blower apparatus (20) has means for rotating the drive shaft (29). A hydraulic motor (25) is suitable for this purpose as shown in FIG. 3. A belt drive or other drive mechanism commonly used in the art may also be employed for this purpose. The drive shaft (29) is connected to the hydraulic motor (25) using a coupler (28). FIG. 3 depicts one end of the crop blower (20) and illustrates the structural member (21), support arm (24), support shaft (35), hydraulic motor (25), shaft coupler (28), drive shaft (29), intake screen (22), blower (26) and motor support bracket (27).

As shown in FIG. 4, a plurality of blowers (26) are mounted rotatably on the drive shaft (29). The blowers (26) create a continuous curtain of air along the length of the crop blower (20). Each blower (26) is associated with an individual drive shaft section (29). FIG. 7 is a cross sectional view of the blowers (26), drive shaft (29), bearing units (30) and support plates (34) respectively. Blowers (26) are mounted on the drive shaft (29) by means of discs (51) with integral hubs (52) and set screws (57). Blower blade units (53) are attached to discs (51) by means of mechanical fasteners such as clamps, sheet metal screws or blind rivets (58).

FIG. 9 is a partial exploded view of a blower (26), showing blower blade section (53), drive shaft (29), and disc (51). In one embodiment, a blade section (53) is made of perforated sheet metal, with the edges remaining un-perforated to allow for attachment to discs (51) with mechanical fasteners such as screws or rivets. One or more intermediate un-perforated bands between the two ends may be provided for support and attachment to intermediate discs when required on longer blower blade sections. The use of perforated metal to form a plurality of smaller blower blades having a radial arc separation of between approximately 5°-15°, and preferably about 10°, is advantageous for several reasons. First it has been found that this configuration will move a significant volume of air at lower rotary speeds compared to blowers having individually extruded blades. In adverse crop conditions which require significant air force, the blower may operate at lower rotary speeds. Second, the cost of producing the perforated sheet metal blowers is significantly lower then producing individually extruded bladed blowers. Finally, the perforated sheet metal blowers are much simpler to construct and replace than the individually extruded bladed blowers.

FIG. 9A is a partial enlarged view of a portion of a blower blade section, showing more clearly the configuration. The blade ends are shown partially sheared, with the un-sheared portion being slightly twisted when the blade angles are set. The blade ends may also be formed without shearing, by using a metal with adequate deep-drawing properties.

FIG. 10 is a view of an alternate blower construction, using individual formed or extruded blade sections (55), mounted in slots in discs (54) with blades (55) held in place with metal or plastic bands (56), the bands being secured with screws, rivets, welding, crimping, or other means. It should be understood that any other type of suitable tangential blower assembly might be used in the present invention.

The crop blower (20) has an air intake which can be a removable intake screen (22) as shown in the figures, or any other suitable grill or mesh. The screen (22) prevents the entry of chafe and other physical waste into the crop blower (20). The intake screen (22) is releasably attached to one or both of the structural member (21) and the vortex stabilizer (36), or the vortex stabilizer support (37). The crop blower (20) also has a vortex stabilizer (36). FIG. 4A depicts the vortex stabilizer (36) which holds in place a rotating cylinder of air, smaller in diameter than the blower (26) itself, and in close proximity to the portion of the vortex stabilizer which is closest to the blower (26). The vortex stabilizer is preferably made of sheet metal and is attached to end plates (32) and support plates (34) with mechanical fasteners or by welding. FIG. 4B shows a sheet metal piece (37) used to provide additional structural support to the vortex stabilizer (36), and is similarly attached to end plates (32) and/or support plates (34).

The crop blower (20) has lower housing (38) that is attached to the end plates (32) and to intermediate support plates (34), and to structural member (21) with mechanical fasteners or by welding. The lower housing (38) may be constructed from sheet metal. The lower housing (38) is in front of and below the blower (26) as shown in FIG. 2, and cooperates with a rearwardly extending portion of the vortex stabilizer (36) on the underside to form a discharge duct (17) for the air flow from the blower (26). Both the rearwardly extending portion of the vortex stabilizer (36) and the lower housing (38) may be shaped in a concave fashion to assist with air flow efficiency and guidance.

As shown in FIG. 2, the blower (26) and duct (17) are positioned such that greater than 145° of the circumference of the blower (26) is exposed to the duct, and preferably about 170° to about 180°. This is greater than existing blowers which typically only have about 900 of the blower circumference exposed to the discharge duct. The additional exposure increases the comparative airflow at any given speed.

The crop blower (20) has means for mounting it to a combine harvester in a position forward of the crop receiving portion of the combine. As show in FIG. 1, mounting arms (23) and (24) pivotally engage fixed support shaft members (35) at each end of the crop blower (20) mounting arm (23) is fitted with two lugs (31) which each have holes of appropriate diameter and location to receive a pin through the upper end of a hydraulic or electric jack, the lower end of which is connected in like manner to lugs or holes on or in end plate (32) of the crop blower (20). A further plate (33) may be attached to the structural member (21) in a position near each end of the crop blower (20), and provides additional, inner-support to support shafts (35). Support shafts (35) attach rotatably in the ends of support arms (23) and (24) which in turn mount upon and are attached to the reel support arms of a commercially available combine harvester machine. The angle of the crop blower (20) relative to the crop and the distance of the crop blower (20) from the cutting equipment on the combine may be adjusted using the mounting arms (23,24) and the associated support shafts (35).

One problem associated with crop blowers having a series of tangential fans is that the airflow at each end of the blower is less than the airflow in the middle. This reduced airflow at the ends can be insufficient to effectively keep the table ends clear of crop materials resulting in blockages. In one embodiment of the present invention, centrifugal blowers are placed at each end of the blower (20) to boost the airflow to those areas. FIG. 11 is a rear isometric view of a supplemental centrifugal blower (63) to be used in conjunction with the other tangential blowers (26). One relatively narrow forward-curve centrifugal blower (63) having end plates (60 and (61) is attached to each end of the crop blower (20) to provide an increased flow of air at the ends of the crop blower, where sometimes, in certain conditions, airflow with only the tangential blowers is insufficient. End plate (61) of the centrifugal blower may be releasably attached to the end plate (32) of the blower (20). The centrifugal blower (63) may have a blower diameter equal to or somewhat greater than the blower diameter of the tangential blowers (26). The housing (65) surrounds centrifugal blower (63) except at the airflow exit areas and has a scroll shape, consistent with standard practice for forward-curve centrifugal blowers. Air is drawn in through a radiused inlet ring (62) that is attached to end plate (60) of the centrifugal blower (63) with mechanical fasteners such as screws. The centrifugal blower (63) used can be any suitable commercially available type. Housing (65) may be welded to end plates (60) and (61), but the housing (65) could also be flanged and fastened to end plates (60) and (61) with mechanical fasteners such as bolts or screws. End plate (60) may be flared out in the air exit area to allow airflow to spread outward.

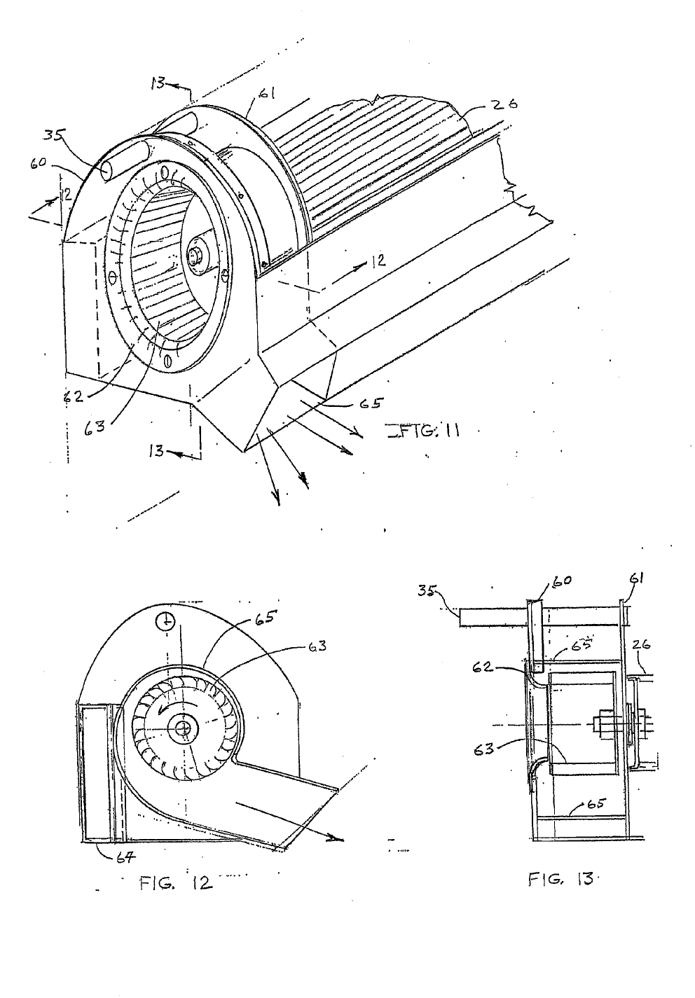

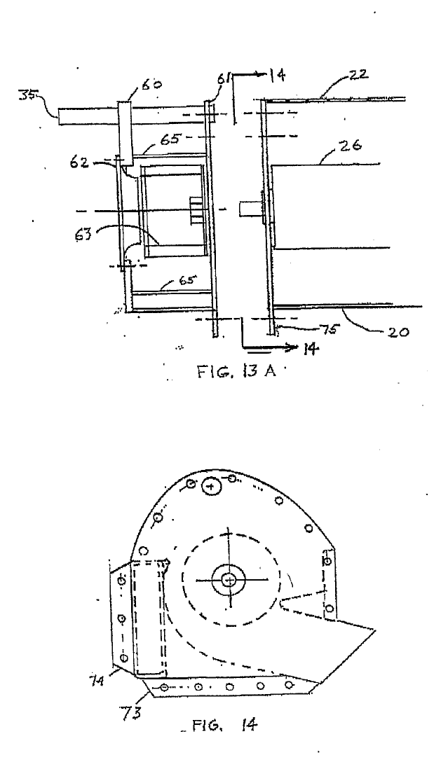

FIG. 12 is a sectional end view of the centrifugal blower (63) and housing (65). Drive shaft (29) sectional length of the end tangential blowers (26) may be of shorter length such that in a blower incorporating the use of end centrifugal blowers, end plates (60) of the centrifugal blower (63) would be the same distance apart as the end plates (32) of the blower (20) with only tangential blowers.

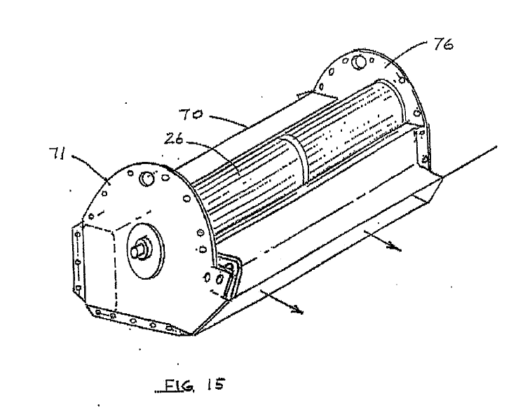

FIG. 13 is a cross-sectional view from behind, looking forward at the auxiliary forward-curve centrifugal blower (63) on the left-hand end of the crop blower (20). FIG. 13A is rear sectional view of one end of a crop blower adjacent to an end of a centrifugal blower (63) which is attachable to the crop blower (20) by means of bolts or other mechanical fastening devices and by using bolting flanges (73), (74) and (75). A completed crop blower (20) may have supplemental centrifugal blowers (63) at each end of the crop blower (20). Bolting flanges (73), (74) and (75) may be integral to end plates (32) of the crop blower and end plate (61) of the centrifugal blower.

FIG. 14 is an end view of a crop blower (20), showing end plate (60) and bolting flanges (73) and (74) which may be integral with end plate (32).

It should be understood that while the embodiment depicted in the diagrams has the centrifugal blowers (63) attached the outside of the blower end plates (32), the blower could be constructed such that individually housed centrifugal blowers are positioned inside the end plates (32). Such interiorly positioned centrifugal blowers could be releasably attached to the end plate (32) and structural member (21) using such suitable means like bolts or screws, or alternatively they could be permanently attached by welding or other suitable fastening means.

The present invention also provides a means for extending the length of the apparatus if required. FIG. 15 depicts an extension blower unit (70) that can be added to the ends of the blower (20). Crop blower extensions would allow a machinery dealer or distributor to stock a standard, common width of crop blower, for example 20 or 24 ft, which are common sizes of crop cutter bar/header or table of combine harvesters whilst giving them the ability to increase the width of the crop blower if required by attaching extensions to one or both ends.

The extension blower unit (70) has a drive shaft section that would interconnect with the main drive shaft (29) and a tangential blower (26). Like the main blower, the extension unit has an intake screen and a discharge duct. The extension unit (70) has end plates (71) and (76) which can be fastened to the blower end plates (32).

To extend the width of the crop blower (20), supplemental centrifugal blowers (63) are removed (if being used) and extension blower (70) is attached in its place. The supplemental centrifugal blower (63) is then attached to the end of the extension blower unit (70). This may be done on both ends if required to achieve the desired width. End drive shafts (29) may need exchanging for the correct end drive configuration shown in FIGS. 7 and 8.

To repair a damaged bearing unit (30) within the blower (20), the intake screen (22) for the corresponding blower (26) is first removed. Next the perforated sheet metal blower halves (26) are removed from the disc (51) connecting them to the relevant section of the drive shaft (29). The set-screws holding the disks (51) proximate to bearing unit (30) that requires attention are loosened and the discs (51) are moved towards the middle of the drive shaft section (29). The bolts holding the bearing units (30) in place at each end of the relevant drive shaft section (26) are removed and the bearing units (30) are moved towards the middle of the drive shaft section (29). The drive shaft section can then be removed and the failed bearing unit (30) can be removed and replaced or repaired. The process is reversed to reinsert the bearing units (30) and the drive shaft section (29). In this manner, a failed bearing can be replaced by simply removing one section of the drive shaft and associated blower assembly. It should understood that the bearing units (30) can be mounted to the intermediate supports plates (34) using various flange and disc arrangements which will permit the bearing unit (30) to be moved laterally.

As will be apparent to those skilled in the art, various modifications, adaptations and variations of the foregoing specific disclosure can be made without departing from the scope of the invention claimed herein.

What is claimed is:

1. A crop blower apparatus for use with a combine harvester having a crop receiving portion, the apparatus comprising:
(a) an elongate structural member having a substantially perpendicular end plate at each end, each end plate having a bearing unit;
(b) a drive shaft comprised of a plurality of axially aligned interconnected sections, the drive shaft extending continuously between the end plates in an orientation that is substantially parallel to the elongate structural member;
(c) a plurality of intermediate support plates for supporting the drive shaft, the intermediate support plates being attached to the structural member in a substantially perpendicular orientation, and each intermediate support plate having a bearing unit;
(d) means for rotating the drive shaft;
(e) a plurality of blowers mounted to and aligned with the axis of the drive shaft;
(f) a lower housing attached to the end plates, the structural member and the intermediate support plates;
(g) a vortex stabilizer attached to the end plates, the structural member and the intermediate support plates, the lower housing and vortex stabilizer cooperating to form a discharge duct for directing the air flow generated by the blowers;
(h) an air intake releasably attached to the structural member and the vortex stabilizer;
(i) means for mounting the crop blower to the combine harvester in a position forward of the crop receiving portion of the combine harvester;
(j) the crop blower apparatus further comprising any one or more features selected from the group consisting of:
(i) means for extending the length of the crop blower;
(ii) positioning of the discharge duct and blower such that greater than 145° of the circumference of the blower is exposed to the discharge duct;
(iii) a centrifugal blower releasably attached to each end plate aligned with the blowers for increasing the air flow at the ends of the crop blower;
(iv) the blowers being formed from sheet metal that has been perforated to form a plurality of blades; and
(v) the drive shaft sections being interconnected by torque transferring means, the drive shaft sections being positioned such that the drive shaft sections interconnect within the bearing units located on the intermediate support plates.

2. The apparatus of claim 1 wherein the selected feature comprises means for extending the length of the crop blower.

3. The apparatus of claim 1 wherein the selected feature comprises positioning of the discharge duct and blower such that greater than 145° of the circumference of the blower is exposed to the discharge duct.

4. The apparatus of claim 1 wherein the selected feature comprises a centrifugal blower releasably attached to each end plate aligned with the blowers for increasing the air flow at the ends of the crop blower.

5. The apparatus of claim 1 wherein the selected feature comprises the blowers being formed from sheet metal that has been perforated to form a plurality of blades.

6. The apparatus of claim 1 wherein the selected feature comprises the drive shaft sections being interconnected by torque transferring means, the drive shaft sections being positioned such that the drive shaft sections interconnect within the bearings located on the intermediate support plates or the end plate.

7. The apparatus of claim 1 wherein the means for extending the length of the crop blower comprises at least one extension blower unit having at least one additional drive shaft section, at least one additional blower, an air intake and a discharge duct, the extension blower unit being releasably attachable to either one of the end plates.

8. The apparatus of claim 1 wherein the means for mounting the crop blower to the harvester comprises a two support shaft members extending out of the end of the crop blower, each support shaft being attached to a mounting arm.

9. The apparatus of claim 1 wherein the means for rotating the drive shaft comprises a hydraulic motor.

10. The apparatus of claim 1 wherein the means for rotating the drive shaft comprises a belt drive.

11. The apparatus of claim 1 wherein the blowers comprise tangential flow fans.

12. The apparatus of claim 1 wherein the air intake comprises a removable screen.

13. The apparatus of claim 1 wherein the blowers comprise two semi circular sections of perforated sheet metal attached to at least one disc that is concentrically attached to the drive shaft.

14. The apparatus of claim 1 further comprising intermediate bearing unit supports connected to the structural member for supporting the drive shaft sections.

15. The apparatus of claim 14 wherein the vortex stabilizer and lower housing is also attached to the intermediate support members.

16. A crop blower apparatus for use with a combine harvester having a crop receiving portion, said apparatus comprising:
(a) an elongate structural member having a substantially perpendicular end plate at each end, each end plate having a bearing;
(b) a drive shaft comprised of a plurality of axially aligned interconnected sections, the drive shaft extending continuously between the end plates in an orientation that is substantially parallel to the elongate structural member;
(c) a plurality of intermediate support plates for supporting the drive shaft, the intermediate support plates being attached to the structural member in a substantially perpendicular orientation, and each intermediate support plate having a bearing;
(d) means for rotating the drive shaft;
(e) a plurality of blowers mounted to and aligned with the axis of the drive shaft;
(f) lower housing attached to the end plates, the structural member and the intermediate support plates
(g) a vortex stabilizer for stabilizing the vortex within the blowers and column of blown air generated by the blowers, the vortex stabilizer being attached to the end plates, the structural member and the intermediate support plates, the lower housing and vortex stabilizer cooperating to form a discharge duct for directing the air flow generated by the blowers;
(h) an air intake releasably attached to one or both of the structural member and the vortex stabilizer;
(i) means for mounting the crop blower to the combine harvester in a position forward of the crop receiving portion of the combine harvester;
(j) an individually housed centrifugal blower at each end of the drive shaft for increasing the air flow at the ends of the crop blower.
